(19) United States
(12) Patent Application Publication
(10) Pub. No.: US 2020/0114714 A1
(43) Pub. Date: Apr. 16, 2020

(54) AUTOMATED GUIDED VEHICLE WITH ROCKER SUSPENSION

(71) Applicant: Fori Automation, Inc., Shelby Township, MI (US)

(72) Inventor: Paul Geoge DOAN, Macomb, MI (US)

(21) Appl. No.: 16/599,626

(22) Filed: Oct. 11, 2019

Related U.S. Application Data
(60) Provisional application No. 62/744,829, filed on Oct. 12, 2018.

(51) Int. Cl. B60G 5/01; G05D 1/02; B60B 33/00; B60G 21/04; B62D 61/10

(52) U.S. Cl. CPC B60G 5/01; G05D 1/021; B60G 2300/07; B60G 21/04; B62D 61/10; B60B 33/0015

(57) ABSTRACT

An automated guided vehicle (AGV) includes a suspension system for movably coupling wheels of the AGV with its frame. The system includes a rocker pivotally attached to the frame. A drive wheel and casters are mounted to the rocker on opposite sides of the rocker pivot axis so that the drive wheel and the pair of casters move together about the pivot axis in the same rotational direction when the rocker tilts. The system can be employed in a simple and elegant manner to ensure continuous traction between the drive wheel and the ground while protecting the drive unit from overload when the AGV traverses uneven terrain.

### TECHNICAL FIELD

The field of technology generally relates to automated guided vehicles (AGVs) and, more particularly, to suspension systems for AGVs.

### BACKGROUND

AGVs are used to haul relatively heavy payloads between locations in manufacturing facilities and may be designed to transport payloads that are several times their own weight. AGV drive systems are selected to provide sufficient power to move a particular size of payload while the size of the drive system is minimized to avoid extraneous weight and to increase energy efficiency by using as little power as possible to propel the AGV. AGV suspension systems are designed to ensure that the powered wheel(s) of the drive system maintain contact with the ground, particularly on uneven surfaces. For instance, when a powered wheel encounters a low spot along the ground, traction will be lost if only unpowered wheels are supporting the AGV away from the low spot. Some suspension systems include means for biasing the powered wheel toward the ground to maintain contact when such low spots are encountered. This can be problematic, however, when a powered wheel encounters a high spot, as the additional force applied by the biasing means can cause the powered wheel to be loaded beyond its capacity. This can lead to stalling or irreparable damage to the drive system. Complex and expensive biasing means must often be used to prevent overloading of the drive system.

### SUMMARY

Various embodiments of an automated guided vehicle (AGV) include a frame a drive-steer unit with a steerable drive wheel, a pair of casters, and a suspension system. The suspension system includes a rocker pivotally attached to the frame for movement about a pivot axis. The drive-steer unit is attached to the rocker on one side of the pivot axis, and the pair of casters is attached to the rocker on an opposite side of the pivot axis. The drive-steer unit and the pair of casters move together about the pivot axis in the same rotational direction when the rocker tilts about the pivot axis.

In various embodiments, the drive wheel is located along a longitudinal axis of the AGV, and each caster is longitudinally and transversely spaced from the drive wheel to establish three-point contact beneath the suspension system.

In various embodiments, the AGV includes an additional drive wheel and an additional pair of casters, and the suspension system includes an additional rocker pivotally attached to the frame for movement about a different pivot axis. The additional drive wheel and pair of casters are attached to the additional rocker to move together about the different pivot axis in the same rotational direction when the additional rocker tilts about the different pivot axis.

In various embodiments, each rocker of the AGV is configured to move independently from the other about respective pivot axes.

In various embodiments, each drive wheel of the AGV is located along a longitudinal axis of the AGV and each caster is longitudinally and transversely spaced from each drive wheel to establish three-point contact beneath each rocker.

In various embodiments, each drive wheel of the AGV is located longitudinally and transversely between casters of the AGV.

In various embodiments, each drive wheel of the AGV is steerable.

In various embodiments, the drive-steer unit and the pair of casters are rigidly mounted to the rocker such that there is no relative movement between the rocker and the drive-steer unit or between the rocker and the pair of casters about the pivot axis when the rocker tilts about the pivot axis.

In various embodiments, the drive wheel is steerable about a steering axis and each caster is configured to swivel about a respective swivel axis. The steering axis and the swivel axes remain parallel with each other when the rocker tilts about the pivot axis.

In various embodiments, the suspension system includes a retraction mechanism configured to tilt the rocker while the AGV is stationary such that the drive wheel is lifted away from the ground and only the casters support the weight of the AGV.

In various embodiments, a drive axis and a steering axis of the drive-steer unit intersect.

In various embodiments, a drive axis of the drive wheel is spaced from the pivot axis by a first distance, and a rolling axis of each caster is spaced from the pivot axis by a second distance different from the first distance, whereby a ratio of drive wheel load to the load on the pair of casters is inversely proportional to a ratio of the second distance to the first distance.

In various embodiments, the distance between a drive axis and the pivot axis is constant and the distance between a caster rolling axis and the pivot axis is a function of the direction of movement of the AGV along the ground.

In various embodiments, a load distribution between the drive wheel and the pair of casters is such that the drive wheel has sufficient traction with the ground to propel the AGV along the ground in an unloaded condition of the AGV and the drive wheel load is less than a rated load of the drive-steer unit in a maximum load condition of the AGV.

In various embodiments, the load distribution between the drive wheel and the pair of casters is constant as the AGV moves along the ground and the rocker tilts in response to uneven conditions along the ground.

In various embodiments, the suspension system does not rely on a biasing element to maintain traction between the drive wheel and the ground.

In various embodiments, an automated guided vehicle (AGV) includes a drive wheel and a pair of casters. The drive wheel is free to move about a pivot axis, and the pair of casters is configured to move about the pivot axis with the drive wheel. A steering axis of the drive wheel and swivel axes of the casters are on opposite sides of the pivot axis and tilt in the same direction as the AGV moves along uneven ground.

In various embodiments, the AGV includes a rocker which is free to move about the pivot axis. The drive wheel and the pair of casters are mounted to the rocker such that a distance between the steering axis and the swivel axes is constant.

In various embodiments, the drive wheel and the pair of casters are coupled with a frame of the AGV via a suspension system having a load distribution ratio between the drive wheel and the pair of casters that is inversely proportional to distances of their respective rolling axes from the pivot axis.

In various embodiments, the load distribution ratio is constant at any given position of the casters about the respective swivel axes.

It is contemplated than any of the above-listed features can be combined with any other feature or features of the above-described embodiments or the features described below and/or depicted in the drawings, except where there is an incompatibility of features.

### BRIEF DESCRIPTION OF DRAWINGS

FIG. 1 is an isometric view of the top of an exemplary AGV equipped with an embodiment of a suspension system;

FIG. 2 is an isometric view of the bottom of the AGV of FIG. 1;

FIG. 3 is a cutaway side view of the AGV of FIGS. 1 and 2;

FIG. 4 is a schematic version of FIG. 3 illustrating the suspension system moving over level ground;

FIG. 5 is a schematic version of FIG. 3 illustrating the suspension system moving over uneven ground;

FIG. 6 is a perspective view of an exemplary drive-steer unit of the AGV;

FIG. 7 is a top perspective view of a portion of an exemplary suspension system including a rocker with the drive-steer unit of FIG. 6 attached;

FIG. 8 is a bottom perspective view of the portion of the suspension system of FIG. 7;

FIG. 9 is a side view of the suspension system of FIGS. 7 and 8 illustrated with a caster swiveled away from the drive-steer unit;

FIG. 10 is a side view of the suspension system of FIG. 9 illustrated with the caster swiveled toward the drive-steer unit;

FIG. 11 is a schematic version of FIG. 9 illustrating distances among various axes; and

FIG. 12 is a schematic version of FIG. 10 illustrating distances among the axes of FIG. 11.

### DESCRIPTION OF ILLUSTRATIVE EMBODIMENTS

As disclosed below, a freely pivoting AGV suspension system can be employed in an unexpectedly simple and elegant manner to ensure continuously sufficient traction between powered wheels and the ground while protecting the drive system from overload.

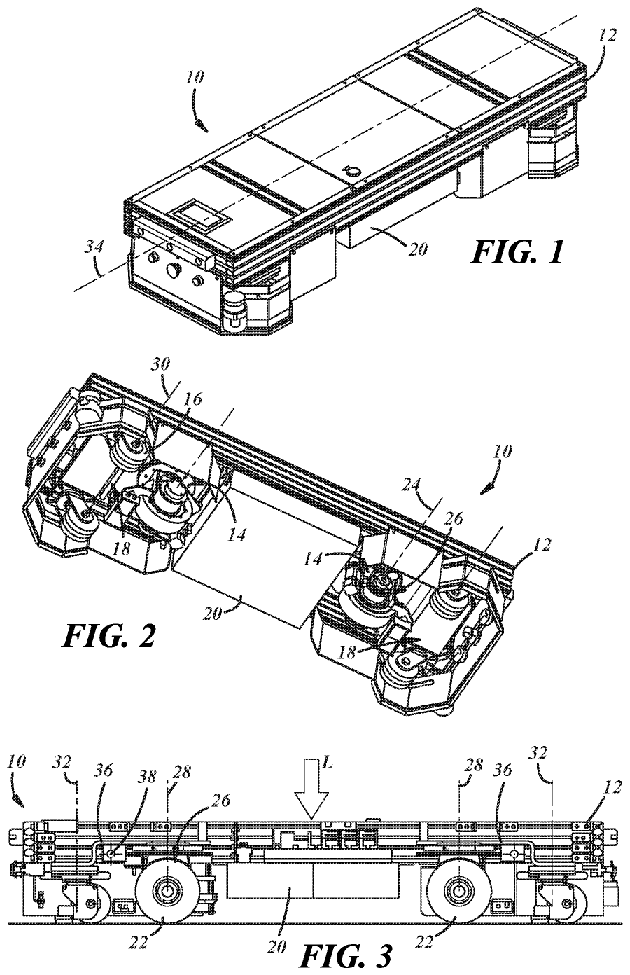

FIGS. 1 and 2 are isometric views of the top and bottom of an exemplary AGV 10 including a frame 12, a drive system 14, casters 16, and a suspension system 18. The AGV 10 is an unmanned vehicle that moves along the ground from place to place without the need for real-time human guidance. An on-board power source such as a rechargeable battery pack 20 powers the drive system 14 to move the AGV 10, and one or more wheels of the AGV are steerable to change the direction of movement. The AGV 10 includes control systems to automatically control propulsion and steering to move along a pre-determined path to a desired destination. These control systems may include or interact with any number of different types of navigation systems. For example, the pre-determined path may be programmed into the control system so that the AGV 10 follows the path based on distances traveled in each direction as measured by encoders or some other type of positioning system. Or the AGV 10 may use sensors to follow an electromagnetic field or visible path laid out along the ground between destinations. Various other types of control systems are possible, and the suspension system 18 is applicable to any type of AGV.

The frame 12 is a structural component that other AGV components are attached to and/or supported by and can be of any shape or size sufficient to bear the loads the AGV is intended to transport. In this case, the frame 12 provides and/or supports a flat platform onto which loads can be placed to be transported, or from which functional components such as equipment attachment mechanisms can extend. In the illustrated example, the frame 12 centrally houses or supports a housing for electronics associated with the AGV control system above the battery pack 20. Other AGV components attached to or supported by the illustrated frame 12 include the suspension system 18 and various guards, covers, user interface panels, and safety sensors.

With additional reference to the cutaway side view of FIG. 3, the drive system 14 includes one or more drive wheels 22 configured to contact the ground, to support at least a portion of the weight of the AGV 10, and to rotate about a drive axis 24 to move the AGV along the ground. In this particular example, the drive system 14 includes two drive-steer units 26 in which the drive wheels 22 are steerable about respective steering axes 28. In this example, the drive axis 24 of each drive wheel 22 intersects the steering axis 28 of the same wheel such that the drive wheel is steerable about the contact point between the wheel and ground. Each steering axis 28 is vertical, and each drive axis 24 is horizontal. Each drive-steer unit 26 combines propulsion and steering in a single assembly and are discussed further below. Other embodiments may include propulsion and steering functions in separate assemblies, such as a steering unit or system that rotates non-driven wheels about a steering axis or a drive unit that includes a non-steerable drive wheel.

Each caster 16 includes an unpowered and free-rolling wheel in a caster frame. The casters 16 support at least a portion of the weight of the AGV 10 and its payload and may support all of the load when the drive wheels are retracted. Each caster wheel is free to rotate about a rolling axis 30, and each caster is free to swivel about a swivel axis 32. The center of each caster wheel is laterally offset from the corresponding swivel axis 32 so that when the AGV changes direction along the ground, the casters swivel to allow the AGV to roll in the direction the steerable drive wheels 22 move it. In this example, each swivel axis 32 is vertical, and each rolling axis 30 is horizontal.

In the illustrated example, both drive wheels 22 are located along a central longitudinal axis 34 of the AGV, and each caster 16 is longitudinally and transversely spaced from the drive wheels 22. A triangular relationship between each drive wheel 22 and an associated pair of casters 16 establishes three-point contact beneath the suspension system 18 at both opposite ends of the AGV 10. The casters 16 are arranged as the outermost wheels of the AGV 10, with the drive wheels 22 located between opposite pairs of casters. The illustrated configuration has a zero turning radius and can be translated and/or rotated along the ground in any orientation—i.e., there is no designated front or back of the AGV.

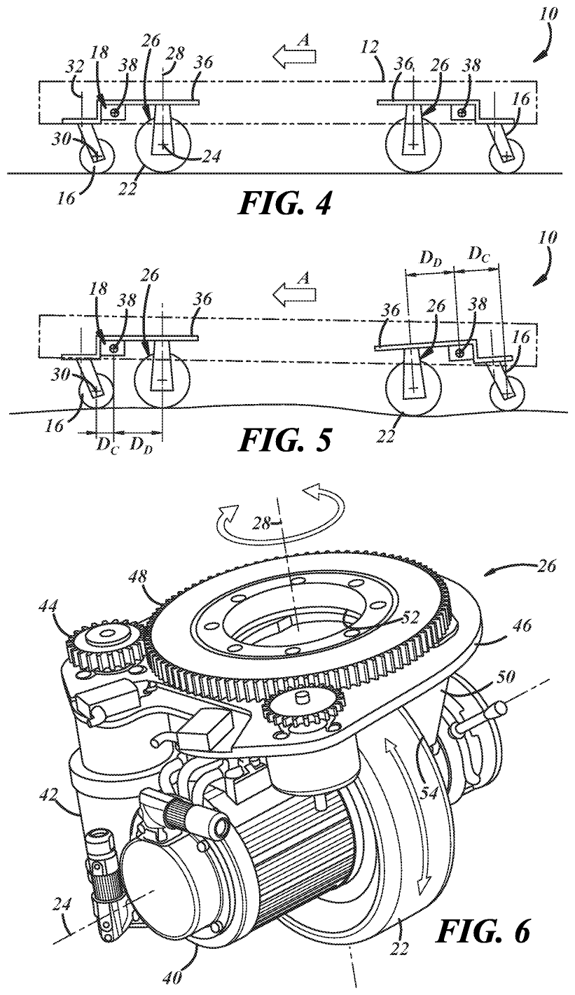

As shown in FIGS. 4 and 5, the suspension system 18 movably couples the casters 16 and drive wheels 22 with the frame 12. As discussed in more detail below, the suspension system 18 includes one or more rockers 36 pivotally attached to the frame 12 for movement about a pivot axis 38. A pair of the casters 16 and a drive-steer unit 26 are attached to each rocker 36 with the casters 16 on one side of the pivot axis 38 and the drive-steer unit 26 on an opposite side of the pivot axis. Each drive-steer unit 26 and the pair of casters 16 attached to the same rocker 36 thus move together about the pivot axis 38 in the same rotational direction when the rocker tilts about the pivot axis. In the illustrated example, the suspension system 16 includes two rockers 36 spaced apart along the length of the AGV 10 with each rocker pivotally attached to the frame for movement about different pivot axes 38. In this arrangement, each rocker 36 moves independently from the other about their respective pivot axes.

FIG. 4 is a simplified schematic version of FIG. 3 with the AGV 10 moving over level ground, and FIG. 5 illustrates operation of the suspension system 18 as the AGV moves over uneven ground. The illustrated suspension system 18 includes two rockers 36, with a pair of transversely spaced casters 16 and a drive-steer unit 26 attached to each rocker. The casters 16 swivel in a direction opposite the direction A of AGV movement. One pair of casters 16 (the leftmost pair in FIGS. 4 and 5) is swiveled toward the drive wheel 22 of the same rocker, and the other pair of casters is swiveled away from its corresponding drive wheel.

Each drive-steer unit 26 and each pair of casters 16 are rigidly mounted to the corresponding rocker 36 such that there is no relative movement between the rocker and the drive-steer unit or between the rocker and the pair of casters about the pivot axis 38 when the rocker tilts about the pivot axis, as is the case when the AGV 10 moves over uneven ground as in FIG. 5. In FIG. 5, the wheels attached to the forwardmost rocker 36 in the direction of AGV movement are on higher and more even ground relative to the wheels attached to the rearmost rocker. The rearmost drive wheel 22 is in a low spot, and the rearmost pair of casters 16 is on higher ground than the rearmost drive wheel but lower than the forwardmost wheels. While this situation may be exaggerated relative to most manufacturing facility floors, it effectively illustrates operation of the suspension system 18. The rearmost rocker 36 is tilted about its pivot axis 38 to maintain contact between the drive wheel and the ground.

The effect of the rocker-based suspension system 18, in which the casters 16 freely pivot with the associated drive unit 26 and drive wheel 22, is that the load distribution among the drive wheels and caster wheels is essentially unchanged from the level ground of FIG. 4 to the uneven ground of FIG. 5. As is ascertainable from FIG. 5, an AGV with no suspension system—i.e., one in which the drive units 26 and casters 16 are rigidly mounted to the AGV frame—would lose traction at the rear drive wheel 22 due to loss of contact with the ground. While an AGV equipped with means for biasing the drive wheels toward the ground (e.g., via a loaded spring) may be tuned to maintain drive wheel traction at such low spots, the effect of such a system is to shift or redistribute some of the weight of the AGV and its payload to the casters 16 as the biasing means becomes less compressed. Traction can be lost and/or casters can be overloaded without proper suspension tuning in such a case. That type of suspension system also shifts load from casters to drive wheel when the drive wheel moves over a high spot along the ground, potentially overloading the drive wheel without proper tuning. Additionally, if such a suspension system is tuned to achieve traction when an AGV is transporting a heavy payload, the biasing force may be too high when the load is removed, causing instability of the AGV.

The illustrated rocker suspension system 18 maintains an essentially constant load on the drive wheels 22 and casters 16 as the AGV moves in a particular direction along uneven ground. The only significant change in load distribution between the drive wheel 22 and casters 16 attached to the same rocker is when the AGV changes direction and the casters swivel in response. In FIGS. 4 and 5, the forwardmost drive wheel 22 is in a minimum load condition, with the distance Dc between the associated caster wheels and pivot axis 38 at a minimum. The rearmost drive wheel 22 is in a maximum load condition, with the distance Dc between the associated caster wheels and pivot axis 38 at a maximum. The distance DD between each drive wheel 22 and its associated pivot axis 38 is constant. These wheel-to-pivot axis distances define a load distribution ratio which is discussed further below.

FIG. 6 is a perspective view of an exemplary drive-steer unit 26, which includes the drive wheel 22, a drive motor 40, and a steering motor 42. The drive motor 40 is positioned along the drive axis 24 and may directly drive the drive wheel 22 or be coupled with the drive wheel via a drive transmission such that the drive wheel rotates at a different speed than the motor. The steering motor 42 rotates a concentric steering gear 44 about a steering motor axis via a shaft that extends through a drive unit plate 46. This steering gear 44 is intermeshed with a stationary gear 48, which is mounted directly to or at a fixed location relative to the suspension system rocker 36. When the steering motor 42 is activated, the steering gear 44 travels around the stationary gear 48, and the plate 46 rotates about the steering axis 28. A wheel mount 50 is affixed to the plate 46 and also rotates about the steering axis. The wheel mount 50 has an upper ring portion 52 that turns within an open center of the stationary gear 48 and a lower portion 54 to which the drive wheel 22 is rotationally mounted along the drive axis 24. The entire drive-steer unit 26 except for the stationary gear 48 thus rotates about the steering axis 28 when the steering motor 42 is activated. Other types of drive-steer units are possible. While drive-steer units may be more costly than simpler and separate drive motors and steering mechanisms on different wheels, they can offer better AGV control, and their cost premium may be offset by the low complexity of the rocker suspension system 18.

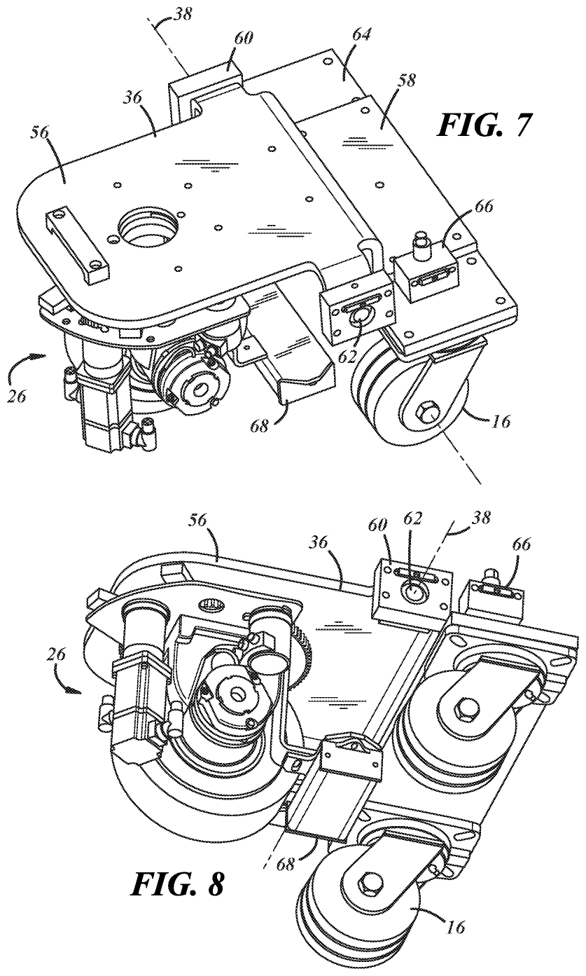

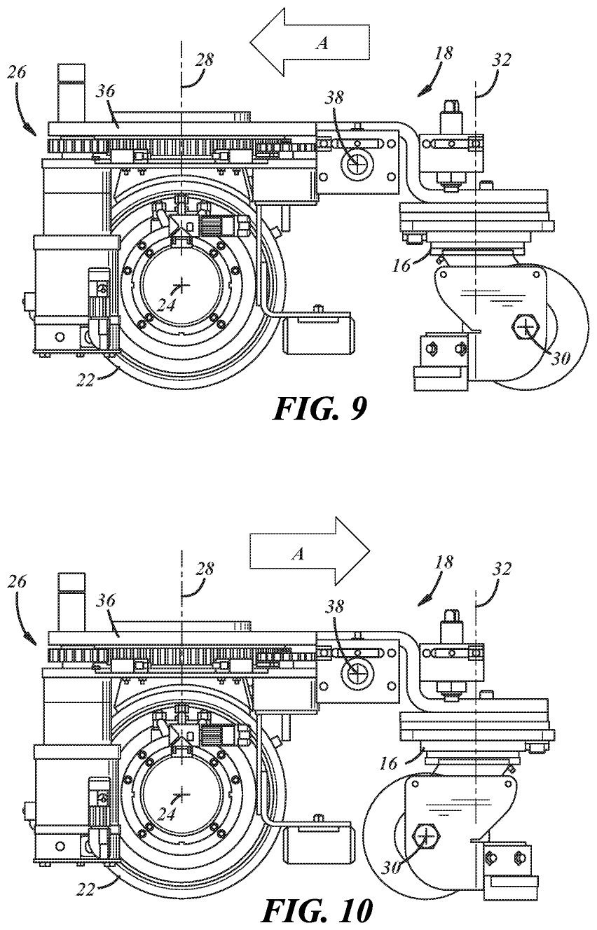

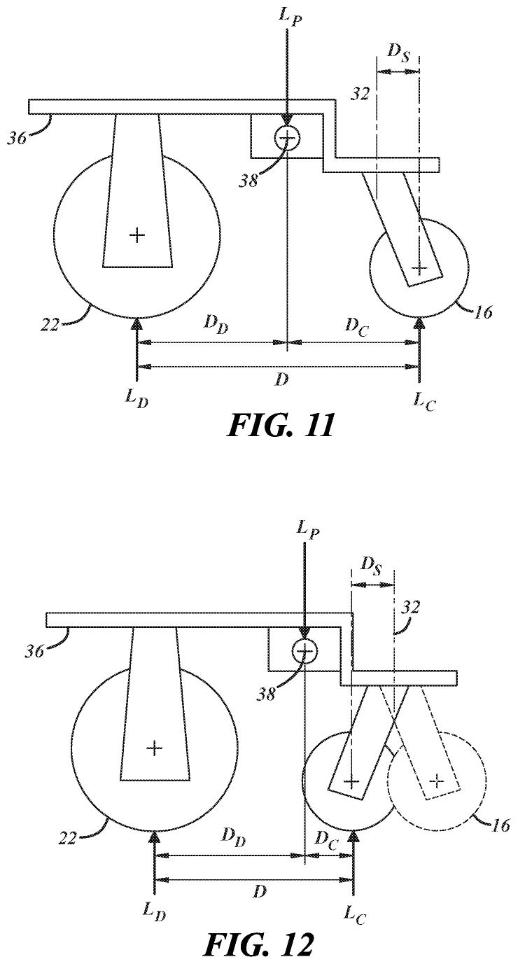

FIGS. 7 and 8 are respective top and bottom perspective views of one of the drive-steer units 26 and a pair of the casters 16 mounted to one of the rockers 36. The rocker 36 has a drive side 56 and a caster side 58 extending in opposite longitudinal directions away from the pivot axis 38. In this example, both sides 56, 58 of the rocker 36 are generally flat and vertically offset from each other. In particular, the drive side 56 is offset vertically above the pivot axis 38, and the caster side 58 is offset vertically below the pivot axis. The rocker 36 thus has a stepped shape when viewed from the side (see FIGS. 9 and 10). The rocker 36 is pivotally mounted to the AGV frame via transversely spaced pivot blocks 60 rigidly mounted to or at a fixed location with respect to the frame. Each pivot block 60 has an inner bearing surface within which an axle 62 is contained via a bearing or other low friction connection. The axle 62 extends from the rocker 36 and does not move with respect to the rocker. Alternatively, a fixed axle could extend from the AGV frame to interface with a bearing surface that moves with the rocker 36. In this case, a pair of arms extend downward from transversely opposite sides of the drive side 56 of the rocker 36, and the axles 62 extends outward from the arms along the pivot axis 38. Other pivotable mount configurations may be used.

The illustrated example also includes a caster mounting plate 64, to which the pair of casters 16 is mounted and which couples the casters to the caster side 58 of the rocker 36. A drive retractor 66 may be mounted to the rocker 36 or mounting plate 64 on the caster side 58 of the rocker. First and second portions of the drive retractor are vertically adjustable relative to one another (e.g., via a threaded connection), with one portion fixed with respect to the AGV frame and the other portion fixed with respect to the rocker 36. When adjusted, the drive retractor 66 causes the rocker 36 to pivot about the pivot axis 38, with the casters 16 rotated downward and the drive unit 26 rotated upward. The drive wheel 22 can be lifted from the ground in this manner to allow the AGV to be towed or otherwise easily moved when not powered. Also illustrated in the example of FIGS. 7 and 8 is a sensor portion 68 of the AGV navigation system.

FIGS. 9 and 10 are side views of the suspension system 18 with attached drive unit 26 and casters 16 with some of the components from the previous description labeled with corresponding reference numerals. FIG. 9 illustrates the casters 16 swiveled away from the drive wheel 22 while moving along the ground in a direction of travel A, and FIG. 10 illustrates the same casters swiveled toward the drive wheel when the direction of travel is reversed. The AGV illustrated in FIGS. 1-5 is configured such that one pair of casters 16 is swiveled toward the corresponding drive wheel 22 and one pair of casters is swiveled away from the drive wheel when the AGV moves in either of the two opposite longitudinal directions.

The rocker suspension system simplifies suspension design because the load on the drive wheels 22 does not change as the AGV traverses uneven terrain. With known AGV weight and payload, suspension design is a matter of ensuring the drive wheel has sufficient traction at the minimum load condition and that it is not overloaded at the maximum load condition. The amount of unevenness of the ground is not a factor. The amount of load on each drive wheel is a function of a simple ratio based on the relative spacing among the drive wheel, the casters of the same rocker, and the pivot axis of the rocker, as explained below.

FIGS. 11 and 12 schematically illustrate the respective minimum and maximum load conditions on one of the drive wheels 22 based on which way the casters 16 are swiveled. Because of the pivot joint between the frame and rocker 36, the load distribution between the drive wheel 22 and the pair of casters 16 is inversely proportional to their respective distances from the pivot axis 38:

$$\frac{{L}_{D}}{{L}_{C}} = \frac{{D}_{C}}{{D}_{D}} . \qquad ( 1 )$$

The load distribution between the drive wheel and casters for each rocker thus depends on the direction of AGV travel, but it is constant for each set of casters and drive wheels while traveling in one direction. The wheel loads L_{D} and L_{C} are also related to the load L_{P} at the pivot axis 38 by:

L_{P}=L_{D}+L_{C}. (2)

In the examples of FIGS. 1-5, L_{P} is one half of the combined weight of the AGV and its payload, less the weight of the rocker assembly. To specify a proper load distribution, two extreme limits are accounted for. Traction must be maintained at the drive wheel 22, so a minimum value for L_{D} must be attained when the AGV is not carrying any cargo and when the casters 16 are swiveled toward the drive wheel as in FIG. 12. Also, the maximum load of the drive wheel cannot be exceeded when the AGV is carrying its maximum rated load and when the casters 16 are swiveled away from the drive wheel as in FIG. 11. Stated differently:

L_{T}≤L_{D}≤Lₘₐₓ (3)

where L_{T} is the minimum load to maintain traction on the drive wheel when the AGV is unloaded and when the casters are swiveled toward the drive wheel, and Lₘₐₓ is the maximum allowable load on the drive wheel—i.e., the rated load of the drive wheel as specified by the manufacturer. L_{T} can be determined as:

$${L}_{T} = \frac{2.5 {R}_{R}}{{μ}_{S}} \qquad ( 4 )$$

where R_{R} is the rolling resistance of the AGV and μ_{S} is the static coefficient of friction between the drive wheel and the ground. R_{R} can be determined as:

$${R}_{R} = ( \frac{{L}_{C}}{{R}_{C}} + \frac{{L}_{D}}{{R}_{D}} ) {μ}_{R} \qquad ( 5 )$$

where R_{C} is the radius of the caster wheels, R_{D} is the radius of the drive wheel, L_{C} is the load on the caster wheels, and μ_{R} is the coefficient of rolling friction between the wheels and the ground. The minimum traction load L_{T} is thus a function of the load L_{D} on the drive wheel and the load L_{C} on the pair of caster wheels. Each of the loads L_{D} and L_{C} can be calculated based on the relationships in equations (1) and (2), above. Iterative calculations can thus be performed to determine a sufficient load distribution that will satisfy equation (3) above to always have sufficient traction and to never exceed the rated load of the drive wheel.

In one non-limiting example based on FIGS. 1-5, an AGV weighs 1200 lbs. and has a maximum rated cargo load of 8500 lbs. The combined weight of a suspension rocker with the drive unit and casters is 300 lbs, and the drive wheels have a maximum rated load of 2200 lbs. The distance between the steering axis and the swivel axis, which is a constant, is 14.5 inches, the drive wheel has a 5-inch radius, and the casters have a 3-inch radius. The distance D_{D} is also constant at 9 inches. The caster offset Ds from the swivel axis 32 to the caster rolling axis is a constant 2.5 inches, which determines the maximum and minimum values for D and D_{C}.

To determine the maximum load on the drive wheel with this configuration, the condition in FIGS. 9 and 11 with the casters swiveled away from the drive wheel is used, and the maximum payload of 8500 lbs. is assumed. With the casters swiveled away from the drive wheel, D=17 inches and D_{C}=8 inches. The load L_{P} at each pivot axis is half the combined weight of the payload and AGV, less the weight of the rocker assembly, or 4550 lbs. The load LD on the drive wheel, based on equations (1) and (2) is:

$${L}_{D} = \frac{{L}_{P} {D}_{C}}{D} \qquad ( 6 )$$

or 2141 lbs., which is below the 2200 lb. maximum load for the drive wheels. The load distribution of the rocker suspension system with these dimensions among the wheels and the pivot axis is therefore suitable to protect the drive system from excess loading.

To determine the minimum load on the drive wheel with this configuration, the condition in FIGS. 10 and 12 with the casters swiveled toward the drive wheel is used, and a no-payload condition is assumed. With the casters swiveled toward the drive wheel, D=12 inches and D_{C}=3 inches. The load L_{P} at each pivot axis is half the weight of the AGV with no payload, less the weight of the rocker assembly, or 300 lbs. The load on the drive wheel, based on equation (6) is then L_{D}=75 lbs, which makes L_{C}=225 lbs.

To ensure this value for L_{D} is sufficient to maintain traction, the minimum load required for traction at the drive wheel is calculated using equations (4) and (5). Assuming the wheels have a coefficient of rolling friction of 0.06, then R_{R}=5.4 lbs. Substituting into equation (4) with a static friction coefficient of 0.5 gives L_{T}=27 lbs. The minimum drive wheel load L_{D} of 75 lbs. exceeds the minimum load L_{T} required to maintain traction. Notably, these calculations are independent from the amount of unevenness along the ground. By its nature, the rocker suspension system ensures constant loading of the drive wheel as the AGV moves in any given direction. No spring or other biasing means is required to maintain traction.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An automated guided vehicle (AGV), comprising:
a frame;
a drive-steer unit, comprising a steerable drive wheel;
a pair of casters; and
a suspension system comprising a rocker pivotally attached to the frame for movement about a pivot axis,
wherein the drive-steer unit is attached to the rocker on one side of the pivot axis and the pair of casters is attached to the rocker on an opposite side of the pivot axis, whereby the drive-steer unit and the pair of casters move together about the pivot axis in the same rotational direction when the rocker tilts about the pivot axis.

2. The AGV of claim 1, wherein the drive wheel is located along a longitudinal axis of the AGV and each caster is longitudinally and transversely spaced from the drive wheel to establish three-point contact beneath the suspension system.

3. The AGV of claim 1, further comprising an additional drive wheel and an additional pair of casters, wherein the suspension system further comprises an additional rocker pivotally attached to the frame for movement about a different pivot axis, the additional drive wheel and pair of casters being attached to the additional rocker to move together about the different pivot axis in the same rotational direction when the additional rocker tilts about the different pivot axis.

4. The AGV of claim 3, wherein the rockers are configured to move independently from each other about the respective pivot axes.

5. The AGV of claim 3, wherein the drive wheels are located along a longitudinal axis of the AGV and each caster is longitudinally and transversely spaced from each drive wheel to establish three-point contact beneath each rocker.

6. The AGV of claim 5, wherein the drive wheels are located longitudinally and transversely between the casters.

7. The AGV of claim 3, wherein the additional drive wheel is steerable.

8. The AGV of claim 1, wherein the drive-steer unit and the pair of casters are rigidly mounted to the rocker such that there is no relative movement between the rocker and the drive-steer unit or between the rocker and the pair of casters about the pivot axis when the rocker tilts about the pivot axis.

9. The AGV of claim 1, wherein the drive wheel is steerable about a steering axis and each caster is configured to swivel about a respective swivel axis, wherein the steering axis and the swivel axes remain parallel with each other when the rocker tilts about the pivot axis.

10. The AGV of claim 1, wherein the suspension system further comprises a retraction mechanism configured to tilt the rocker while the AGV is stationary such that the drive wheel is lifted away from the ground and only the casters support the weight of the AGV.

11. The AGV of claim 1, wherein a drive axis and a steering axis of the drive-steer unit intersect.

12. The AGV of claim 1, wherein a drive axis of the drive wheel is spaced from the pivot axis by a first distance, and a rolling axis of each caster is spaced from the pivot axis by a second distance different from the first distance, whereby a ratio of drive wheel load to the load on the pair of casters is inversely proportional to a ratio of the second distance to the first distance.

13. The AGV of claim 12, wherein the first distance is constant and the second distance is a function of the direction of movement of the AGV along the ground.

14. The AGV of claim 12, wherein a load distribution between the drive wheel and the pair of casters is such that the drive wheel has sufficient traction with the ground to propel the AGV along the ground in an unloaded condition of the AGV and the drive wheel load is less than a rated load of the drive-steer unit in a maximum load condition of the AGV.

15. The AGV of claim 1, wherein the load distribution between the drive wheel and the pair of casters is constant as the AGV moves along the ground and the rocker tilts in response to uneven conditions along the ground.

16. The AGV of claim 1, wherein the suspension system does not rely on a biasing element to maintain traction between the drive wheel and the ground.

17. An automated guided vehicle (AGV) comprising a drive wheel which is free to move about a pivot axis and a pair of casters configured to move about the pivot axis with the drive wheel, wherein a steering axis of the drive wheel and swivel axes of the casters are on opposite sides of the pivot axis and tilt in the same direction as the AGV moves along uneven ground.

18. The AGV of claim 17, further comprising a rocker which is free to move about the pivot axis, wherein the drive wheel and the pair of casters are mounted to the rocker such that a distance between the steering axis and the swivel axes is constant.

19. The AGV of claim 17, wherein the drive wheel and the pair of casters are coupled with a frame of the AGV via a suspension system having a load distribution ratio between the drive wheel and the pair of casters that is inversely proportional to distances of their respective rolling axes from the pivot axis.

20. The AGV of claim 17, wherein the load distribution ratio is constant at any given position of the casters about the respective swivel axes.
